(19) United States
(12) Patent Application Publication
(10) Pub. No.: US 2024/0161465 A1
(43) Pub. Date: May 16, 2024

(54) IMAGE PROCESSING METHOD AND APPARATUS, COMPUTER DEVICE, AND STORAGE MEDIUM

(71) Applicant: TENCENT TECHNOLOGY (SHENZHEN) COMPANY LIMITED, Shenzhen (CN)

(72) Inventors: Keke HE, Shenzhen (CN); Junwei ZHU, Shenzhen (CN); Ying TAI, Shenzhen (CN); Chengjie WANG, Shenzhen (CN)

(73) Assignee: TENCENT TECHNOLOGY (SHENZHEN) COMPANY LIMITED., Shenzhen (CN)

(21) Appl. No.: 18/416,382

(22) Filed: Jan. 18, 2024

Related U.S. Application Data
(63) Continuation of application No. PCT/CN2023/113992, filed on Aug. 21, 2023.

(30) Foreign Application Priority Data
Sep. 5, 2022 (CN) 202211075798.7

(51) Int. Cl. G06V 10/774; G06V 10/74; G06V 10/75; G06V 10/776; G06V 10/80; G06V 10/82; G06V 40/16

(52) U.S. Cl. CPC G06V 10/774; G06V 10/751; G06V 10/761; G06V 10/776; G06V 10/806; G06V 10/82; G06V 40/162; G06V 40/168

(57) ABSTRACT

An image processing method including obtaining a fake template sample group comprising a first source image, a real labeled image, and a fake template image, inputting the fake template image into an identity swapping model to obtain a first identity swapping image of the fake template image, obtaining a fake labeled sample group comprising a second source image, a real template image, and a fake labeled image, the fake labeled image being based on identity swapping processing of the real template image, inputting the real template image into the identity swapping model to obtain a second identity swapping image of the real template image, and training the identity swapping model based on the fake template sample group, the first identity swapping image, the fake labeled sample group, and the second identity swapping image to generate a trained identity swapping model.

### CROSS-REFERENCE TO RELATED APPLICATIONS

This application is a continuation application of International Application No. PCT/CN2023/113992 filed on Aug. 21, 2023, which claims priority to Chinese Patent Application No. 202211075798.7, filed with the China National Intellectual Property Administration on Sep. 5, 2022, the disclosures of each of which being incorporated by reference herein in their entireties.

### FIELD

The disclosure relates to the field of computer technologies, and in particular, to an image processing method and apparatus, a computer device, and a computer-readable storage medium.

### BACKGROUND

With rapid development of artificial intelligence technologies, image identity swapping is widely used in services scenarios related to images, videos, and the like. The image identity swapping refers to swapping an identity of an object in a source image into a template image by using an identity swapping model. An obtained identity swapping image (fake) keeps an expression of the object, a posture of the object, clothing of the object, a background of the object, and the like in the template image unchanged, and the identity swapping image has the identity of the object in the source image.

In the related art, there is no real labeled image in an image identity swapping task. Therefore, the identity swapping model is usually trained through an unsupervised training procedure. To be specific, the source image and the template image are inputted into the identity swapping model, and the identity swapping model outputs the identity swapping image, to perform feature extraction on the identity swapping image to perform loss constraining. An unsupervised training procedure of a related art identity swapping model makes a training process of the identity swapping model uncontrollable because there is no real labeled image to constrain the identity swapping model. As a result, an identity swapping image generated by the identity swapping model has poor quality.

### SUMMARY

Some embodiments provide an image processing method, performed by an electronic device, including: obtaining a fake template sample group including a first source image, a real labeled image, and a fake template image, the fake template image being obtained by performing identity swapping processing on the real labeled image, the first source image and the real labeled image having a same identity attribute, and the fake template image and the real labeled image having a same non-identity attribute; inputting the fake template image into an identity swapping model and performing identity swapping processing on the fake template image based on the first source image, to obtain a first identity swapping image of the fake template image; obtaining a fake labeled sample group including a second source image, a real template image, and a fake labeled image, the fake labeled image being based on identity swapping processing of the real template image based on the second source image, the second source image and the fake labeled image having a same identity attribute, and the real template image and the fake labeled image having a same non-identity attribute; inputting the real template image into the identity swapping model and performing identity swapping processing on the real template image based on the second source image, to obtain a second identity swapping image of the real template image; and training the identity swapping model based on the fake template sample group, the first identity swapping image, the fake labeled sample group, and the second identity swapping image, to generate a trained identity swapping model to perform identity swapping processing on a target template image based on a target source image.

Some embodiments provide an image processing apparatus including: at least one memory configured to store program code and at least one processor configured to read the program code and operate as instructed by the program code, the program code including: obtaining code configured to cause at least one of the at least one processor to obtain a fake template sample group comprising a first source image, a real labeled image, and a fake template image, the fake template image being based on identity swapping processing of the real labeled image, the first source image and the real labeled image having a same identity attribute, and the fake template image and the real labeled image having a same non-identity attribute; and processing code configured to cause at least one of the at least one processor to input the fake template image into an identity swapping model and perform identity swapping processing on the fake template image based on the first source image, to obtain a first identity swapping image of the fake template image, wherein the obtaining code is further configured to cause at least one of the at least one processor to obtain a fake labeled sample group comprising a second source image, a real template image, and a fake labeled image, the fake labeled image being based on identity swapping processing of the real template image based on the second source image, the second source image and the fake labeled image having a same identity attribute, and the real template image and the fake labeled image having a same non-identity attribute; and the processing code is further configured to cause at least one of the at least one processor to: input the real template image into the identity swapping model and perform identity swapping processing on the real template image based on the second source image, to obtain a second identity swapping image of the real template image; and train the identity swapping model based on the fake template sample group, the first identity swapping image, the fake labeled sample group, and the second identity swapping image to generate a trained identity swapping model to perform the identity swapping processing on a target template image based on a target source image.

Some embodiments provide a non-transitory computer-readable storage medium storing computer code which, when executed by at least one processor, causes the at least one processor to at least: obtain a fake template sample group comprising a first source image, a real labeled image, and a fake template image, the fake template image being based on identity swapping processing of the real labeled image, the first source image and the real labeled image having a same identity attribute, and the fake template image and the real labeled image having a same non-identity attribute; input the fake template image into an identity swapping model and perform identity swapping processing on the fake template image based on the first source image to obtain a first identity swapping image of the fake template image; obtain a fake labeled sample group comprising a second source image, a real template image, and a fake labeled image, the fake labeled image being obtained by performing the identity swapping processing on the real template image based on the second source image, the second source image and the fake labeled image having a same identity attribute, and the real template image and the fake labeled image having a same non-identity attribute; input the real template image into the identity swapping model and perform identity swapping processing on the real template image based on the second source image to obtain a second identity swapping image of the real template image; and train the identity swapping model based on the fake template sample group, the first identity swapping image, the fake labeled sample group, and the second identity swapping image to generate a trained identity swapping model to perform the identity swapping processing on a target template image based on a target source image.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an image identity swapping process according to some embodiments.

FIG. 2 is a schematic structural diagram of an image processing system according to some embodiments.

FIG. 3 is a schematic flowchart of an image processing method according to some embodiments.

FIG. 4 is a schematic structural diagram of an identity swapping model according to some embodiments.

FIG. 5 is a schematic flowchart of another image processing method according to some embodiments.

FIG. 6 is a schematic diagram of a training procedure of an identity swapping model according to some embodiments.

FIG. 7 is a schematic structural diagram of an image processing apparatus according to some embodiments.

FIG. 8 is a schematic structural diagram of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure and the appended claims.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

To more clearly describe the technical solutions of some embodiments, related terms are described herein.

(1) Artificial intelligence technology. The artificial intelligence (AI) technology is a theory, method, technology, and application system that uses a digital computer or a machine controlled by the digital computer to simulate, extend, and expand human intelligence, perceive an environment, obtain knowledge, and use knowledge to obtain an optimal result. In other words, AI is a comprehensive technology in computer science, and attempts to understand the essence of intelligence and produce a new intelligent machine that can react in a manner similar to human intelligence. AI is to study design principles and implementation methods of various intelligent machines, so that the machines can perceive, infer, and make decisions. The AI technology is a comprehensive discipline, covering a wide range of fields including both hardware-level technologies and software-level technologies. The basic AI technology generally includes a technology such as a sensor, a dedicated AI chip, cloud computing, distributed storage, a big data processing technology, an operation/interaction system, or mechatronics. AI software technologies mainly include a computer vision technology, a speech processing technology, a natural language processing technology, machine learning/deep learning, unmanned driving, smart transportation, and the like.

(2) Computer vision technology. The computer vision (CV) technology is a science that studies how to use a machine to “see”, and furthermore, that uses a camera and a computer to replace human eyes to perform machine vision such as recognition and measurement on a target, and further perform graphic processing, so that the computer processes the target into an image more suitable for human eyes to observe, or an image transmitted to an instrument for detection. As a scientific discipline, the CV studies related theories and technologies and attempts to establish an AI system that can obtain information from images or multidimensional data. The CV technology generally includes technologies such as image processing, image recognition, image semantic understanding, image retrieval, optical character recognition (OCR), video processing, video semantic understanding, video content/behavior recognition, 3-dimensional object reconstruction, a 3-dimensional (3D) technology, virtual reality, augmented reality, synchronous positioning, and map construction, and further include biological feature recognition technologies such as common face recognition and fingerprint recognition, and living body detection technologies.

(3) Generative adversarial network. The generative adversarial network (GAN) is a method of unsupervised learning, and is formed by two parts: a generative network and a discriminative model. The GAN performs learning by letting the generative model and the discriminative model confront each other. For a basic principle of the GAN, refer to the following descriptions. The generative model may be configured to randomly sample from a latent space as an input, and an output result thereof needs to imitate a real sample in a training set as much as possible; and the discriminative model may use the real sample or the output result of the generative model as an input, to distinguish an output result of the generative model from the real sample as much as possible. In other words, the generative model is required to deceive the discriminative model as much as possible, so that the generative model and the discriminative model confront each other, parameters are constantly adjusted, and a picture that is fake and real is finally generated.

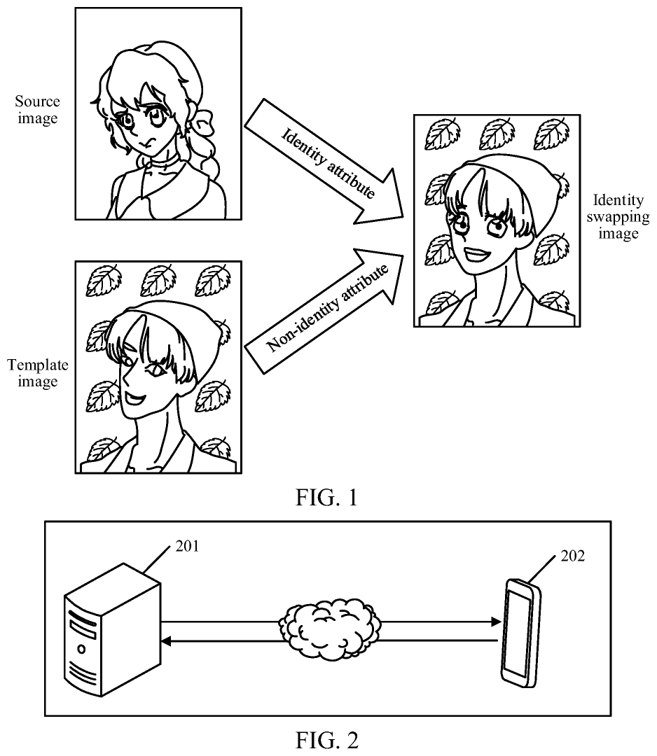

(4) Image identity swapping. The image identity swapping refers to an identity swapping processing process of swapping an identity of an object in a source image into a template image to obtain an identity swapping image (fake). Generally, an identity of an object may be labeled through a face of the object. In other words, the image identity swapping may refer to a process of swapping a face of the object in the source image into the template image to obtain the identity swapping image. Therefore, the image identity swapping may also be referred to as image face changing. After the image identity swapping, the source image and the identity swapping image have a same identity attribute, where the identity attribute refers to an attribute that can label an identity of an object in an image, for example, a face of the object in the image; and the template image and the identity swapping image have a same non-identity attribute, where the non-identity attribute refers to an attribute unrelated to the identity of the object in the image, for example, a hairstyle of the object, an expression of the object, a posture of the object, clothing of the object, or a background of the object. In other words, the identity swapping image keeps the non-identity attribute of the object in the template image unchanged, and has the identity attribute of the object in the source image. FIG. 1 is a schematic diagram of image identity swapping. An object included in a source image is an object 1, and an object included in a template image is an object 2. An identity swapping image obtained through identity swapping processing keeps a non-identity attribute of the object 2 in the template image unchanged, and has an identity attribute of the object 1 in the source image. In other words, an identity of the object 2 in the template image is swapped for that of the object 1 in the identity swapping image.

An unsupervised training procedure of a related identity swapping model makes a training process of the identity swapping model uncontrollable because there is no real labeled image to constrain the identity swapping model. As a result, quality of an identity swapping image generated by the identity swapping model is not high.

Some embodiments provide an image processing method and apparatus, a computer device, and a storage medium, which can make a training process of an identity swapping model more controllable, to help to improve quality of an identity swapping image generated by an identity swapping model.

In some embodiments, to ensure that there is a real labeled image in the training process of the identity swapping model, a fake template method is used to construct one part of training data. In some embodiments, two images of a same object may be selected, where one image is used as a source image, and the other image is used as a real labeled image; and then identity swapping processing of any object is performed on the real labeled image to construct a fake template image, so that the identity swapping model may be trained based on a fake template sample group that is formed by the source image, the fake template image, and the real labeled image.

In some embodiments, to improve consistency between the fake template image and a template image used in a real identity swapping scenario, a fake ground truth (gt) method is used to construct the other part of the training data. In some embodiments, two images of different objects may be selected, where an identity of one object is used as a source image, and an identity of the other object is used as a real template image; and then identity swapping processing is performed on the real template image based on the source image to construct a fake labeled image, so that the identity swapping model may be trained based on a fake labeled sample group that is formed by the source image, the real template image, and the fake labeled image.

The following describes an image processing system applicable to the image processing solution provided in some embodiments and an application scenario of the image processing solution with reference to FIG. 2.

The image processing system shown in FIG. 2 may include a server 201 and a terminal device 202. A quantity of terminal devices 202 is not limited herein, and there may be one or more terminal devices 202. The server 201 may be an independent physical server, or may be a server cluster or a distributed system formed by a plurality of physical servers, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. This is not limited thereto. The terminal device 202 may be a smart phone, a tablet computer, a notebook computer, a desktop computer, an intelligent voice interaction device, a smart watch, an in-vehicle terminal, a smart home appliance, an aircraft, or the like, but is not limited thereto. A direct communication connection may be established between the server 201 and the terminal device 202 through wired communication, or an indirect communication connection may be established through wireless communication, which is not limited herein.

In the image processing system shown in FIG. 2, for a model training stage:
the model training stage may be executed by the server 201, the server 201 may obtain a plurality of fake template sample groups and a plurality of fake labeled sample groups, and then iterative training may be performed on an identity swapping model based on the plurality of fake template sample groups and the plurality of fake labeled sample groups, to obtain a trained identity swapping model.

In the image processing system shown in FIG. 2, for a model application stage:
the model application stage may be executed by the terminal device 202. To be specific, the trained identity swapping model may be deployed in the terminal device 202. When the terminal device 202 has a target source image and a target template image that are to be processed, the terminal device 202 may invoke the trained identity swapping model to perform identity swapping processing on the target template image based on the target source image, to obtain an identity swapping image of the target template image. The identity swapping image of the target template image may keep a non-identity attribute of an object in the target template image unchanged, and the identity swapping image of the target template image has an identity attribute of an object in the target source image.

In some embodiments, the model application stage may be executed through interaction between the server 201 and the terminal device 202. The trained identity swapping model may be deployed in the server 201. When the terminal device 202 has a target source image and a target template image that are to be processed, the terminal device 202 may send the target source image and the target template image to the server 201. The server 201 may invoke the trained identity swapping model to perform identity swapping processing on the target template image based on the target source image, to obtain an identity swapping image of the target template image. Then, the server 201 may send the identity swapping image of the target template image to the terminal device 202. The identity swapping image of the target template image may keep a non-identity attribute of an object in the target template image unchanged, and the identity swapping image of the target template image has an identity attribute of an object in the target source image.

Based on the fake template sample groups and the fake labeled sample groups in the model training stage, the training of the identity swapping model is more controllable, so that quality of the identity swapping image generated by the trained identity swapping model can be improved when image identity swapping is performed by using the trained identity swapping model in the model application stage.

The trained identity swapping model may be applied to application scenarios such as film and television production, game image production, live broadcast virtual image production, and identity photo production.

(1) Film and television production. In the film and television production, some professional action shots are completed by a professional, and an actor may be automatically replaced through image identity swapping later. In some embodiments, image frames including a professional in an action shot video segment may be obtained, and an image including a replacement actor may be used as a source image. Each image frame including the professional is used as a template image and is inputted into the trained identity swapping model together with the source image, to output a corresponding identity swapping image. The outputted identity swapping image swaps an identity of the professional in the template image for an identity of the replacement actor. It can be seen that, through image identity swapping, the film and television production is more convenient, repeated shooting is avoided, and costs of the film and television production are reduced.

(2) Game image production. In the game image production, an image including a character object may be used as a source image, and an image including a game image may be used as a template image. The source image and the template image are inputted into the trained identity swapping model, to output a corresponding identity swapping image. The outputted identity swapping image swaps an identity of the game image in the template image for an identity of the character object in the source image. It can be seen that, through image identity swapping, an exclusive game image for a character may be designed.

(3) Live broadcast virtual image production. In a live broadcast scenario, an image including a virtual image may be used as a source image. Each image frame including a character object in a live broadcast video is used as a template image and is inputted into the trained identity swapping model together with the source image, to output a corresponding identity swapping image. The outputted identity swapping image swaps an identity of the character object in the template image for that of the virtual image. It can be seen that, identity swapping may be performed in the live broadcast scenario by using the virtual image, to improve interestingness of the live broadcast scenario.

(4) Identity photo production. In an identity photo production process, an image of an object whose identity photo needs to be produced may be used as a source image. The source image and an identity photo template image are inputted into the trained identity swapping model, to output a corresponding identity swapping image. The outputted identity swapping image swaps an identity of a template object in the identity photo template image for that of the object whose identity photo needs to be produced. It can be seen that, through image identity swapping, when the object whose identity photo needs to be produced provides one image, the identity photo may be directly produced without shooting, thereby greatly reducing a production cost of the identity photo.

It can be understood that the image processing system described herein is for describing technical solutions of some embodiments more clearly and does not form limits to the technical solutions. It is to be known to those of ordinary skill in the art that, with the evolution of the system architecture and the emerging of new service scenarios, the technical solutions provided herein are applied equally to similar technical problems.

Data related to obtaining an image, a video, or the like of an object in some embodiments is essentially relevant data of the user. When some embodiments are applied to a specific product or technology, the object's permission or consent needs to be obtained, and collection, use, and processing of the relevant data need to comply with relevant laws, regulations, and standards of relevant countries and regions.

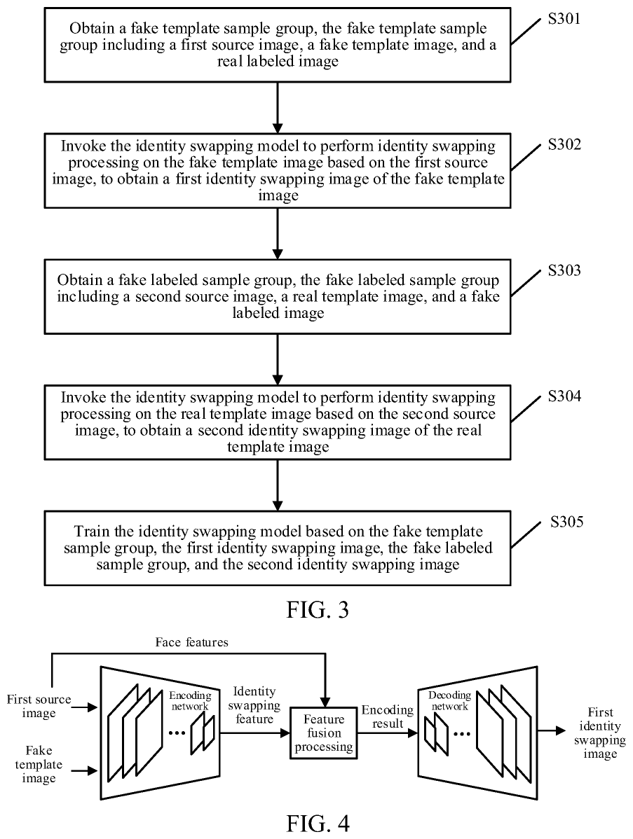

The following describes the image processing method according to some embodiments with reference to FIG. 3 to FIG. 6.

Some embodiments provide an image processing method. The image processing method mainly introduces a preparation process of training data (namely, a fake template sample group and a fake labeled sample group) and a process of performing identity swapping processing by using an identity swapping model. The image processing method may be performed by a computer device, and the computer device may be the server 201 shown in the foregoing image processing system. As shown in FIG. 3, the image processing method may include, but not limited to, operation S301 to operation S305.

S301: Obtain a fake template sample group, the fake template sample group including a first source image, a fake template image, and a real labeled image.

For a process of obtaining the fake template sample group, refer to the following descriptions. The first source image and the real labeled image may be obtained, and the first source image and the real labeled image have a same identity attribute, in other words, the first source image and the real labeled image belong to a same object. Then, identity swapping processing may be performed on the real labeled image, to obtain the fake template image. In this way, the fake template sample group may be generated based on the first source image, the fake template image, and the real labeled image. In some embodiments, the fake template image may be obtained by invoking an identity swapping model to perform identity swapping processing on the real labeled image based on a reference source image, where an object included in the reference source image may be any object other than an object included in the first source image, so that the fake template image and the real labeled image have a same non-identity attribute. The identity swapping model may be a model obtained through preliminary training. For example, the identity swapping model may be a model preliminarily trained through an unsupervised training procedure. For another example, the identity swapping model may be a model preliminarily trained by using the fake template sample group.

For example, two images <A_i, A_j> of a same object may be obtained, where one image A_i is used as a first source image, and the other image A_j is used as a real labeled image. Then, identity swapping processing may be performed on the real labeled image A_j by using a reference source image of any object, to obtain a fake template image, that is, the fake template image=fixed_swap_model_v0 (reference source image, A_j), where fixed_swap_model_v0 indicates a preliminarily trained identity swapping model. In this way, a fake template sample group <A_i, fake template image, A_j> may be formed by the first source image A_i, the fake template image, and the real labeled image A_j.

The first source image may be obtained through face region cropping, and the real labeled image may be obtained through face region cropping. In other words, an initial source image corresponding to the first source image may be obtained, and face region cropping may be performed on the initial source image corresponding to the first source image, to obtain the first source image; and an initial labeled image corresponding to the real labeled image may be obtained, and face region cropping may be performed on the initial labeled image corresponding to the real labeled image, to obtain the real labeled image. A face region cropping process of the first source image is the same as a face region cropping process of the real labeled image. The face region cropping process of the first source image is focused on herein. For the face region cropping process of the real labeled image, refer to the face region cropping process of the first source image. Details are not described herein again. For details of the face region cropping process of the first source image, refer to the following content.

First, face detection may be performed on the initial source image corresponding to the first source image, to determine a face region in the initial source image corresponding to the first source image. Then, in the face region, face registration may be performed on the initial source image corresponding to the first source image, to determine face key points in the initial source image corresponding to the first source image. Then, cropping processing may be performed on the initial source image corresponding to the first source image based on the face key points, to obtain the first source image. Through face region cropping, a learning focus of the identity swapping model may be placed on the face region, to speed up a training procedure of the identity swapping model.

S302: Invoke the identity swapping model to perform identity swapping processing on the fake template image based on the first source image, to obtain a first identity swapping image of the fake template image.

After the fake template sample group including the first source image, the fake template image, and the real labeled image is obtained, the identity swapping model may be invoked to perform identity swapping processing on the fake template image based on the first source image, to obtain the first identity swapping image of the fake template image. FIG. 4 shows a process of invoking, or calling, the identity swapping model to perform identity swapping processing. The identity swapping model may include an encoding network and a decoding network. The encoding network is configured to perform fusion encoding processing on the first source image and the fake template image, to obtain an encoding result. The decoding network is configured to perform decoding processing on the encoding result of the encoding network, to obtain the first identity swapping image of the fake template image.

\textcircled{1} For the encoding network, first, after the first source image and the fake template image are inputted into the encoding network, splicing processing is performed on the first source image and the fake template image, to obtain a spliced image. The splicing processing herein may, in some embodiments, refer to channel splicing processing. For example, the first source image may include an image with three channels in total: an R channel (red channel), a G channel (green channel), and a B channel (blue channel), and the fake template image may include an image with three channels in total: an R channel (red channel), a G channel (green channel), and a B channel (blue channel). In this case, the spliced image obtained through splicing processing may include an image with six channels. Then, feature learning may be performed on the spliced image, to obtain identity swapping features (where the identity swapping features may be indicated as: swap_features). The feature learning herein may be, in some embodiments, implemented through a plurality of convolutional layers in the encoding network. The encoding network may include the plurality of convolutional layers, and sizes of the plurality of convolutional layers gradually decrease according to an order of convolution processing. After the convolution processing of the plurality of convolutional layers, a resolution of the spliced image is continuously reduced, so that the spliced image is finally encoded as identity swapping features. It is not difficult to see that, through the convolution processing of the plurality of convolutional layers, image features in the first source image and image features in the fake template image are fused in the identity swapping features. Then, feature fusion processing may be performed on the identity swapping features and face features of the first source image (where the face features of the first source image may be indicated as: src1_id_features), to obtain the encoding result of the encoding network. The face features of the first source image may be obtained by performing face recognition processing on the first source image through a face recognition network.

Feature fusion processing may be performed on the identity swapping features and the face features of the first source image in an adaptive instance normalization (AdaIN) manner. The essence of the fusion processing is to perform alignment on a mean and a variance of the identity swapping features and a mean and a variance of the face features of the first source image. A specific process of the fusion processing may include: calculating the mean of the identity swapping features and the variance of the identity swapping features; calculating the mean of the face features of the first source image and the variance of the face features of the first source image; and performing fusion processing on the identity swapping features and the face features of the first source image based on the mean of the identity swapping features, the variance of the identity swapping features, the mean of the face features of the first source image, and the variance of the face features of the first source image, to obtain the encoding result of the encoding network. In some embodiments, refer to the following formula 1:

$$AdaIN ( x , y ) = σ ( y ) ( \frac{x - μ ( x )}{σ ( x )} ) + μ ( y ) \qquad formula 1$$

In the formula 1, AdaIN(x,y) indicates the encoding result of the encoding network, x indicates the identity swapping features (swap_features), y indicates the face features of the first source image (src1_id_features), σ(x) indicates the mean of the identity swapping features (swap_features), μ(x) indicates the variance of the identity swapping features (swap_features), σ(y) indicates the mean of the face features of the first source image (src1_id_features), and μ(y) indicates the variance of the face features of the first source image (src1_id_features).

\textcircled{2} For the decoding network, the decoding processing of the decoding network may be implemented through a plurality of convolutional layers in the decoding network. The decoding network may include the plurality of convolutional layers, and sizes of the plurality of convolutional layers gradually increase according to an order of convolution processing. After the convolution processing of the plurality of convolutional layers, a resolution of the encoding result of the encoding network is continuously increased, so that the encoding result is finally decoded as the first identity swapping image corresponding to the fake template image (where the first identity swapping image may be indicated as: fake template_fake).

S303: Obtain a fake labeled sample group, the fake labeled sample group including a second source image, a real template image, and a fake labeled image.

For a process of obtaining the fake labeled sample group, refer to the following descriptions. The second source image and the real template image may be obtained, and an identity attribute of the second source image is different from an identity attribute of the real template image, in other words, the second source image and the real template image belong to different objects. Then, identity swapping processing may be performed on the real template image based on the second source image, to obtain the fake labeled image. Through identity swapping processing, the second source image and the fake labeled image have a same identity attribute, and the real template image and the fake labeled image have a same non-identity attribute, so that the fake labeled sample group may be generated based on the second source image, the real template image, and the fake labeled image. In some embodiments, the fake labeled image may be obtained by invoking the identity swapping model to perform identity swapping processing on the real labeled image based on the second source image. The identity swapping model may be a model obtained through preliminary training. For example, the identity swapping model may be a model preliminarily trained through an unsupervised training procedure. For another example, the identity swapping model may be a model preliminarily trained by using the fake template sample group.

For example, two images <B_i, C_j> of different objects may be obtained, where one image B_i is used as a second source image, and the other image C_j is used as a real template image. Then, identity swapping processing may be performed on the real template image C_j by using the second source image B_i, to obtain a fake labeled image, that is, the fake labeled image=fixed_swap_model_v0 (second source image B_i, real template image C_j), where fixed_swap_model_v0 indicates the preliminarily trained identity swapping model. In this way, a fake labeled sample group <B_i, C_j, fake labeled image> may be formed by the second source image B_i, the real template image C_j, and the fake labeled image.

The second source image may be obtained through face region cropping, and the real template image may be obtained through face region cropping. In other words, an initial source image corresponding to the second source image may be obtained, and face region cropping may be performed on the initial source image corresponding to the second source image, to obtain the second source image; and an initial template image corresponding to the real template image may be obtained, and face region cropping may be performed on the initial template image corresponding to the real template image, to obtain the real template image. A face region cropping process of the second source image is the same as a face region cropping process of the real template image. The face region cropping process of the second source image is focused on herein. For the face region cropping process of the real template image, refer to the face region cropping process of the second source image. Details are not described herein again. For details of the face region cropping process of the second source image, refer to the following content.

Face detection may be performed on the initial source image corresponding to the second source image, to determine a face region in the initial source image corresponding to the second source image. In the face region, face registration may be performed on the initial source image corresponding to the second source image, to determine face key points in the initial source image corresponding to the second source image. Cropping processing may be performed on the initial source image corresponding to the second source image based on the face key points, to obtain the second source image. Through face region cropping, a learning focus of the identity swapping model may be placed on the face region, to speed up a training procedure of the identity swapping model.

S304: Invoke the identity swapping model to perform identity swapping processing on the real template image based on the second source image, to obtain a second identity swapping image of the real template image.

After the fake labeled sample group including the second source image, the real template image, and the fake labeled image is obtained, the identity swapping model may be invoked to perform identity swapping processing on the real template image based on the second source image, to obtain the second identity swapping image of the real template image. A process of invoking the identity swapping model to perform identity swapping processing on the real template image based on the second source image to obtain the second identity swapping image of the real template image is the same as a process of invoking the identity swapping model to perform identity swapping processing on the fake template image based on the first source image to obtain the first identity swapping image of the fake template image in operation S302. The encoding network in the identity swapping model is configured to perform fusion encoding processing on the second source image and the real template image, to obtain an encoding result. The decoding network in the identity swapping model is configured to perform decoding processing on the encoding result of the encoding network, to obtain the second identity swapping image of the real template image (where the second identity swapping image may be indicated as: fake labeled_fake). For details of a fusion encoding process of the encoding network and a decoding process of the decoding network, refer to descriptions in operation S302. Details are not described again herein.

S305: Train the identity swapping model based on the fake template sample group, the first identity swapping image, the fake labeled sample group, and the second identity swapping image.

After the first identity swapping image and the second identity swapping image are obtained through identity swapping processing, the identity swapping model may be trained based on the fake template sample group, the first identity swapping image, the fake labeled sample group, and the second identity swapping image. In some embodiments, loss information of the identity swapping model may be determined based on the fake template sample group, the first identity swapping image, the fake labeled sample group, and the second identity swapping image. Then, model parameters of the identity swapping model may be updated based on the loss information of the identity swapping model, to train the identity swapping model.

In some embodiments, through a preparation process of a fake template sample group, there may be a real labeled image in a training process of an identity swapping model. In other words, the real labeled image may be used to constrain the training process of the identity swapping model, so that the training process of the identity swapping model may be more uncontrollable, to help to improve quality of an identity swapping image generated by the identity swapping model. Through a preparation process of a fake labeled sample group, a real template image may be consistent with a template image used in a real identity swapping scenario, which makes up for a defect that a fake template image constructed in the fake template sample group is inconsistent with the template image used in the real identity swapping scenario, and further improves controllability of the training process of the identity swapping model and the quality of the identity swapping image generated by the identity swapping model. In addition, before preparing the fake template sample group and the fake labeled sample group, face region cropping is performed on related images, so that important face regions may be more focused on in the training process of the identity swapping model, excessively more background regions in the images may be ignored, and the training process of the identity swapping model may be accelerated.

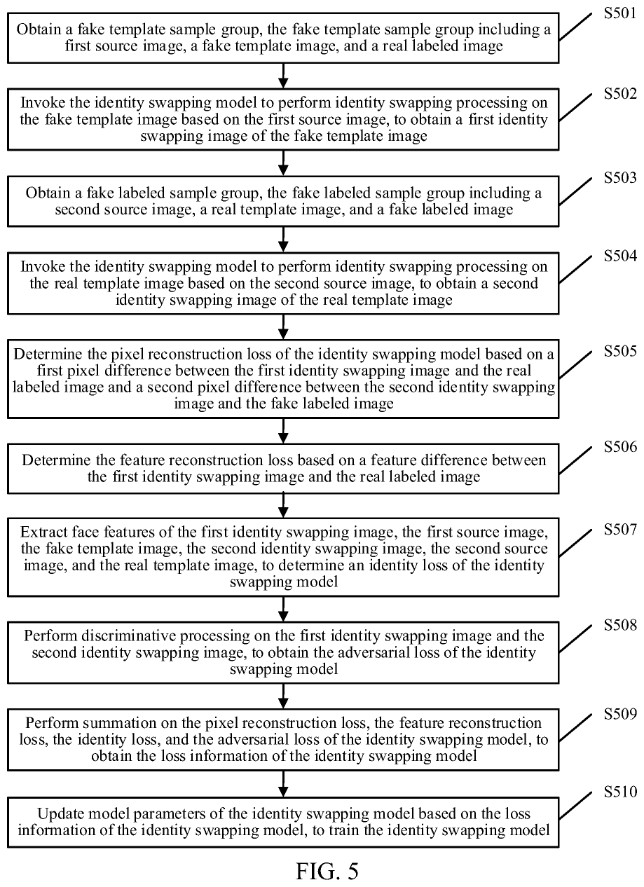

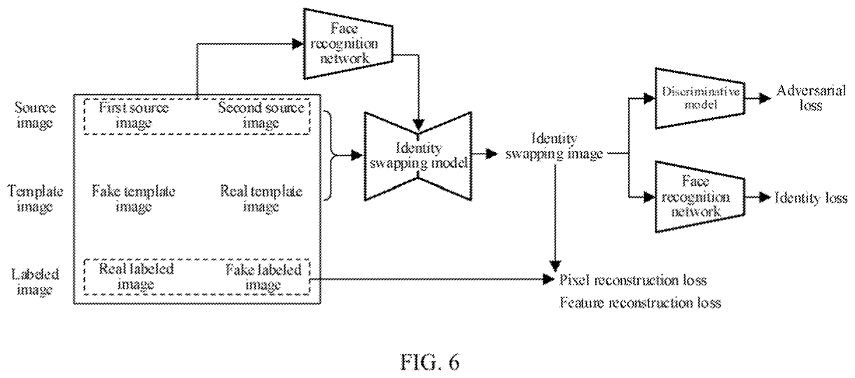

Some embodiments provide an image processing method as shown with FIG. 3. The image processing method mainly introduces construction of the loss information of the identity swapping model. The image processing method may be performed by a computer device, and the computer device may be the server 201 shown in the foregoing image processing system. As shown in FIG. 5, the image processing method may include, but not limited to, operation S501 to operation S510.

S501: Obtain a fake template sample group, the fake template sample group including a first source image, a fake template image, and a real labeled image.

In some embodiments, an execution process of operation S501 is the same as an execution process of operation S301 in the embodiment shown in FIG. 3. For a specific execution process, refer to specific descriptions of operation S301 in the embodiment shown in FIG. 3. Details are not described herein again.

S502: Invoke the identity swapping model to perform identity swapping processing on the fake template image based on the first source image, to obtain a first identity swapping image of the fake template image.

In some embodiments, an execution process of operation S502 is the same as an execution process of operation S302 as shown in FIG. 3. For a specific execution process, refer to specific descriptions of operation S302 as shown in FIG. 3. Details are not described herein again.

S503: Obtain a fake labeled sample group, the fake labeled sample group including a second source image, a real template image, and a fake labeled image.

In some embodiments, an execution process of operation S503 is the same as an execution process of operation S303. For a specific execution process, refer to specific descriptions of operation S303. Details are not described herein again.

S504: Invoke the identity swapping model to perform identity swapping processing on the real template image based on the second source image, to obtain a second identity swapping image of the real template image.

In some embodiments, an execution process of operation S504 is the same as an execution process of operation S304. For a specific execution process, refer to specific descriptions of operation S304. Details are not described herein again.

Through operation S501 to operation S504, the fake template sample group, the first identity swapping image, the fake labeled sample group, and the second identity swapping image may be obtained. Loss information of the identity swapping model may be determined based on the fake template sample group, the first identity swapping image, the fake labeled sample group, and the second identity swapping image, and the identity swapping model may be trained based on the loss information. The loss information of the identity swapping model may be formed by a pixel reconstruction loss of the identity swapping model, a feature reconstruction loss of the identity swapping model, an identity loss of the identity swapping model, and an adversarial loss of the identity swapping model. The following introduces a process of determining the pixel reconstruction loss of the identity swapping model, the feature reconstruction loss of the identity swapping model, the identity loss of the identity swapping model, and the adversarial loss of the identity swapping model with reference to operation S505 to operation S510.

S505: Determine the pixel reconstruction loss of the identity swapping model based on a first pixel difference between the first identity swapping image and the real labeled image and a second pixel difference between the second identity swapping image and the fake labeled image.

In a training procedure of the identity swapping model shown in FIG. 6, for the fake template sample group, the first pixel difference between the first identity swapping image and the real labeled image is a pixel reconstruction loss corresponding to the fake template sample group. The first pixel difference may, in some embodiments, refer to a difference between a pixel value of each pixel point in the first identity swapping image and a pixel value of a corresponding pixel point in the real labeled image. For the fake labeled sample group, the second pixel difference between the second identity swapping image and the fake labeled image is a pixel reconstruction loss corresponding to the fake labeled sample group. The second pixel difference may, in some embodiments, refer to a difference between a pixel value of each pixel point in the second identity swapping image and a pixel value of a corresponding pixel point in the fake labeled image. The pixel reconstruction loss of the identity swapping model may be determined based on the pixel reconstruction loss corresponding to the fake template sample group and the pixel reconstruction loss corresponding to the fake labeled sample group. In other words, the pixel reconstruction loss of the identity swapping model may be determined based on the first pixel difference and the second pixel difference.

The pixel reconstruction loss of the identity swapping model may be a result obtained by performing weighted summation on the first pixel difference and the second pixel difference. In some embodiments, a first weight corresponding to the first pixel difference and a second weight corresponding to the second pixel difference may be obtained. Then, weighted processing may be performed on the first pixel difference based on the first weight, to obtain a first weighted pixel difference, and weighted processing may be performed on the second pixel difference based on the second weight, to obtain a second weighted pixel difference. Then, summation may be performed on the first weighted pixel difference and the second weighted pixel difference, to obtain the pixel reconstruction loss of the identity swapping model. The fake labeled image in the fake labeled sample group is not a real labeled image, which may affect a training effect of the identity swapping model. Therefore, a weight of the pixel reconstruction loss corresponding to the fake labeled sample group may be reduced in the pixel reconstruction loss of the identity swapping model, for example, a weight of the pixel reconstruction loss corresponding to the fake template sample group may be set to be greater than the weight of the pixel reconstruction loss corresponding to the fake labeled sample group may be, in other words, the first weight corresponding to the first pixel difference may be set to be greater than the second weight corresponding to the second pixel difference. For a specific calculation process of the pixel reconstruction loss of the identity swapping model, refer to the following formula 2:

Reconstruction_Loss=a×|fake template_fake−A_j|+b×|fake labeled_fake−fake labeled image| formula 2

In the formula 2, Reconstruction_Loss indicates the pixel reconstruction loss of the identity swapping model; fake template_fake indicates the first identity swapping image of the fake template sample group, A_j indicates the real labeled image, and |fake template_fake−A_j| indicates the first pixel difference; fake labeled_fake indicates the second identity swapping image of the fake labeled sample group, and ‘fake labeled_fake−fake labeled image’ indicates the second pixel difference; and a indicates the first weight, b indicates the second weight, and a>b (for example, a=1, and b=0.1, that is, Reconstruction_Loss=|fake template_fake−A_j|+0.1×|fake labeled_fake−fake labeled image|).

S506: Determine the feature reconstruction loss of the identity swapping model based on a feature difference between the first identity swapping image and the real labeled image.

In operation S505, the difference between the first identity swapping image and the real labeled image is compared from a pixel dimension, and the loss is constructed based on the pixel difference. In operation S506, the difference between the first identity swapping image and the real labeled image is compared from a feature dimension, and the loss is constructed based on the feature difference. In the training procedure of the identity swapping model shown in FIG. 6, the feature reconstruction loss of the identity swapping model may be determined based on the feature difference between the first identity swapping image and the real labeled image.

The feature difference between the first identity swapping image and the real labeled image may be compared layer by layer. In some embodiments, an image feature extraction network may be obtained, where the image feature extraction network includes a plurality of image feature extraction layers; the image feature extraction network may be invoked to perform image feature extraction on the first identity swapping image, to obtain a first feature extraction result, where the first feature extraction result may include an identity swapping image feature extracted from each image feature extraction layer in the plurality of image feature extraction layers; the image feature extraction network may be invoked to perform image feature extraction on the real labeled image, to obtain a second feature extraction result, where the second feature extraction result may include a labeled image feature extracted from each image feature extraction layer in the plurality of image feature extraction layers; and then a feature difference between the identity swapping image feature and the labeled image feature that are extracted from each image feature extraction layer may be calculated, and summation may be performed on feature differences of the image feature extraction layers, so that the feature reconstruction loss of the identity swapping model may be obtained. The image feature extraction network may be a neural network configured to extract image features. For example, the image feature extraction network may be an AlexNet (an image feature extraction network). The plurality of image feature extraction layers used when calculating the feature differences may be all image feature extraction layers or part of image feature extraction layers included in the image feature extraction network. This is not limited herein.

By using an example in which the image feature extraction network includes four image feature extraction layers, for a calculation process of the feature reconstruction loss of the identity swapping model, refer to the following formula 3:

LPIPS_Loss=|result_fea1−result_fea1|+|result_fea2−gt_img_fea2|+|result_fea3−gt_img_fea4|+|result_fea4−gt_img_fea4| formula 3

In the formula 3, LPIPS_Loss indicates the feature reconstruction loss of the identity swapping model; result_feai indicates an identity swapping image feature (i=1, 2, 3, 4) extracted from an i^{th} image feature extraction layer when the image feature extraction network performs image feature extraction on the first identity swapping image; gt_img_feai indicates an labeled image feature extracted from the i^{th} image feature extraction layer when the image feature extraction network performs image feature extraction on the real labeled image; and |result_feai−result_feai| indicates a feature difference between the identity swapping image feature and the labeled image feature that are extracted from the i^{th} image feature extraction layer.

S507: Extract face features of the first identity swapping image, the first source image, the fake template image, the second identity swapping image, the second source image, and the real template image, to determine an identity loss of the identity swapping model.

In operation 507, the face features of the first identity swapping image, the first source image, the fake template image, the second identity swapping image, the second source image, and the real template image may be extracted, and the identity loss of the identity swapping model may be determined by comparing similarities between face features. The face features may be extracted through a face recognition network. The identity loss of the identity swapping model may include a first identity loss and a second identity loss.

The first identity loss is set to hope that face features of a generated identity swapping image is as similar as possible to face features of a source image. Therefore, the first identity loss may be determined based on a similarity between face features of the first identity swapping image and face features of the first source image and a similarity between face features of the second identity swapping image and face features of the second source image. The similarity between the face features of the first identity swapping image and the face features of the first source image may be configured for determining an identity similarity loss corresponding to the fake template sample group, and the similarity between the face features of the second identity swapping image and the face features of the second source image may be configured for determining an identity similarity loss corresponding to the fake labeled sample group. The first identity loss may be formed two parts: the identity similarity loss corresponding to the fake template sample group and the identity similarity loss corresponding to the fake labeled sample group. The first identity loss may be equal to a sum of the identity similarity loss corresponding to the fake template sample group and the identity similarity loss corresponding to the fake labeled sample group. For a calculation process of the identity similarity loss corresponding to the fake template sample group or the identity similarity loss corresponding to the fake labeled sample group, refer to the following formula 4:

ID_Loss=1−cosine_similarity(fake_id_features,src_id_features) formula 4

In the formula 4, ID_Loss indicates the identity similarity loss, fake_id_features indicate face features of an identity swapping image, src_id_features indicate face features of a source image, and cosine_similarity(fake_id_features, src_id_features) indicates a similarity between the face features of the identity swapping image and the face features of the source image. When fake_id_features=fake template_fake_id_features (namely, the first identity swapping image), and src_id_features=src1_id_features (namely, the face features of the first source image), ID_Loss indicates the identity similarity loss corresponding to the fake template sample group. When fake_id_features=fake labeled_fake_id_features (namely, the second identity swapping image), and src_id_features=src2_id_features (namely, the face features of the second source image), ID_Loss indicates the identity similarity loss corresponding to the fake labeled sample group.

For calculation of a similarity between face features, refer to the following formula 5:

$$Cosine\_similarity ( A , B ) = \frac{A \cdot B}{‖ A ‖ ‖ B ‖} = \frac{{\sum }_{j = 1}^{n} {A}_{j} \times {B}_{j}}{\sqrt{{\sum }_{j = 1}^{n} {( {A}_{j} )}^{2}} \times \sqrt{{\sum }_{j = 1}^{n} {( {B}_{j} )}^{2}}} \qquad formula 5$$

In the formula 5, cosine_similarity(A, B) indicates a similarity between a face feature A and a face feature B, Aⱼ indicates components in the face feature A, and Bⱼ indicates components in the face feature B.

The second identity loss is set to hope that the face features of the generated identity swapping image is as dissimilar as possible to face features of a template image. Therefore, the second identity loss may be determined based on a similarity between the face features of the first identity swapping image and face features of the fake template image, a similarity between the face features of the first source image and the face features of the fake template image, a similarity between the face features of the second identity swapping image and face features of the real template image, and a similarity between the face features of the second source image and the face features of the real template image. The similarity between the face features of the first identity swapping image and the face features of the fake template image and the similarity between the face features of the first source image and the face features of the fake template image may be configured for determining an identity non-similarity loss corresponding to the fake template sample group, and the identity non-similarity loss corresponding to the fake template sample group may be equal to the similarity between the face features of the first source image and the face features of the fake template image minus the similarity between the face features of the first identity swapping image and the face features of the fake template image. The similarity between the face features of the second identity swapping image and the face features of the real template image and the similarity between the face features of the second source image and the face features of the real template image may be configured for determining an identity non-similarity loss corresponding to the fake labeled sample group, and the identity non-similarity loss corresponding to the fake labeled sample group may be equal to the similarity between the face features of the second identity swapping image and the face features of the real template image minus the similarity between the face features of the second source image and the face features of the real template image. The second identity loss may be formed two parts: the identity non-similarity loss corresponding to the fake template sample group and the identity non-similarity loss corresponding to the fake labeled sample group. The second identity loss may be equal to a sum of the identity non-similarity loss corresponding to the fake template sample group and the identity non-similarity loss corresponding to the fake labeled sample group. For a calculation process of the identity non-similarity loss corresponding to the fake template sample group or the identity non-similarity loss corresponding to the fake labeled sample group, refer to the following formula 6:

ID_Neg_Loss=|cosine_similarity(fake_id_features,template_id_features)−cosine_similarity(src_id_features,template_id_features)| formula 6

In the formula 6, ID_Neg_Loss indicates an identity non-similarity loss, fake_id_features indicate face features of an identity swapping image, template_id_features indicate face features of a template image, src_id_features indicate face features of a source image, cosine_similarity(fake_id_features, template_id_features) indicates a similarity between the face features of the identity swapping image and the face features of the template image, and cosine_similarity(src_id_features, template_id_features) indicates a similarity between the face features of the source image and the face features of the template image. When fake_id_features=fake template_fake_id_features (namely, the face features of the first identity swapping image), src_id_features=src1_id_features (namely, the face features of the first source image), and template_id_features=fake template_template_id_features (namely, the face features of the fake template image), ID_Neg_Loss indicates the identity non-similarity loss corresponding to the fake template sample group. When fake_id_features=fake labeled_fake_id_features (namely, the face features of the second identity swapping image), src_id_features=src2_id_features (namely, the face features of the second source image), and template_id_features=real_template_id_features (namely, the face features of the real template image), ID_Neg_Loss indicates the identity non-similarity loss corresponding to the fake labeled sample group.

S508: Perform discriminative processing on the first identity swapping image and the second identity swapping image, to obtain the adversarial loss of the identity swapping model.

In the training procedure of the identity swapping model shown in FIG. 6, discriminative processing may be performed on the first identity swapping image and the second identity swapping image, to obtain the adversarial loss of the identity swapping model. In some embodiments, a discriminative model may be obtained; the discriminative model may be invoked to perform discriminative processing on the first identity swapping image, to obtain a first discriminative result, where the first discriminative result may be configured for indicating a probability that the first identity swapping image is a real image; and the discriminative model may be invoked to perform discriminative processing on the second identity swapping image, to obtain a second discriminative result, where the second discriminative result may be configured for indicating a probability that the second identity swapping image is a real image. Then, the adversarial loss of the identity swapping model may be determined based on the first discriminative result and the second discriminative result, where the first discriminative result may be configured for determining an adversarial loss corresponding to the fake template sample group, and the second discriminative result may be configured for determining an adversarial loss corresponding to the fake labeled sample group. The adversarial loss of the identity swapping model may be formed by two parts: the adversarial loss corresponding to the fake template sample group and the adversarial loss corresponding to the fake labeled sample group. The adversarial loss of the identity swapping model may be equal to a sum of the adversarial loss corresponding to the fake template sample group and the adversarial loss corresponding to the fake labeled sample group. For a calculation process of the adversarial loss corresponding to the fake template sample group or the adversarial loss corresponding to the fake labeled sample group, refer to the following formula 7:

G_Loss=log(1−D(fake)) formula 7

In the formula 7, D(fake) indicates a discriminative result for an identity swapping image, and G_Loss indicates an adversarial loss. When fake=fake template_fake (namely, the first identity swapping image), G_Loss may indicate the adversarial loss corresponding to the fake template sample group. When fake=fake labeled_fake (namely, the second identity swapping image), G_Loss may indicate the adversarial loss corresponding to the fake labeled sample group.

S509: Perform summation on the pixel reconstruction loss, the feature reconstruction loss, the identity loss, and the adversarial loss of the identity swapping model, to obtain the loss information of the identity swapping model.

After the pixel reconstruction loss, the feature reconstruction loss, the identity loss, and the adversarial loss of the identity swapping model are determined, summation may be performed on the pixel reconstruction loss, the feature reconstruction loss, the identity loss, and the adversarial loss of the identity swapping model, to obtain the loss information of the identity swapping model. For a specific calculation process of the loss information of the identity swapping model, refer to the following formula 8:

Loss=Reconstruction_Loss+LPIPS_Loss+ID_Loss+ID_Neg_Loss+G_Loss formula 8

In the formula 8, Loss indicates the loss information of the identity swapping model, Reconstruction_Loss indicates the pixel reconstruction loss of the identity swapping model, LPIPS_Loss indicates the feature reconstruction loss of the identity swapping model, ID_Loss indicates the first identity loss of the identity swapping model (which may include the identity similarity loss corresponding to the fake template sample group and the identity similarity loss corresponding to the fake labeled sample group), ID_Neg_Loss indicates the second identity loss of the identity swapping model (which may include the identity non-similarity loss corresponding to the fake template sample group and the identity non-similarity loss corresponding to the fake labeled sample group), and G_Loss indicates the adversarial loss of the identity swapping model (which may include the adversarial loss corresponding to the fake template sample group and the adversarial loss corresponding to the fake labeled sample group).

S510: Update model parameters of the identity swapping model based on the loss information of the identity swapping model, to train the identity swapping model.

In operation S510, after the loss information of the identity swapping model is obtained, the model parameters of the identity swapping model may be updated based on the loss information of the identity swapping model, to train the identity swapping model. The updating model parameters of the identity swapping model based on the loss information of the identity swapping model, to train the identity swapping model may, in some embodiments, refer to optimizing the model parameters of the identity swapping model based on a direction of reducing the loss information. The “based on a direction of reducing the loss information” refers to using minimizing the loss information as a target model optimization direction. By performing model optimization in the direction, loss information generated after the identity swapping model is optimized needs to be less than loss information generated before the identity swapping model is optimized. For example, loss information of the identity swapping model obtained in current calculation is 0.85. In this case, after the identity swapping model is optimized in the direction of reducing the loss information, loss information generated by the optimized identity swapping model needs to less than 0.85.

In operation S501 to operation S510, one training procedure of the identity swapping model is introduced. In an actual training process of the identity swapping model, the training procedure needs to be executed a plurality of times. Each time the training procedure is executed, the loss information of the identity swapping model is calculated once, and the parameters of the identity swapping model are optimized once. If the loss information generated by the identity swapping model after a plurality of times of optimization is less than a loss threshold, it may be determined that the training process of the identity swapping model is over, and the identity swapping model obtained through final optimization may be determined as the trained identity swapping model.

In operation S501 to operation S510, an example in which one training procedure of the identity swapping model uses one fake template sample group and one fake labeled sample group is used for introduction. In the actual training process of the identity swapping model, one training procedure of the identity swapping model may use a plurality of fake template sample groups and a plurality of fake labeled sample groups (for example, one training procedure of the identity swapping model uses 10 fake template sample groups and 20 fake labeled sample groups). In this way, the loss information of the identity swapping model may be determined jointly based on the plurality of fake template sample groups, an identity swapping image of each fake template sample group, the plurality of fake labeled sample groups, and an identity swapping image of each fake labeled sample group. For example, the pixel reconstruction loss of the identity swapping model may be determined jointly based on a pixel reconstruction loss corresponding to each fake template sample group and a pixel reconstruction loss corresponding to each fake labeled sample group. For another example, the feature reconstruction loss of the identity swapping model may be determined jointly based on a feature reconstruction loss corresponding to each fake template sample group.

The trained identity swapping model may be configured to perform identity swapping processing in different scenarios (for example, film and television production, and game image production). After a target source image and a target template image that are to be processed are received, the trained identity swapping model may be invoked to perform identity swapping processing on the target template image based on the target source image, to obtain an identity swapping image of the target template image, where the target source image and the identity swapping image of the target template image have a same identity attribute, and the target template image and the identity swapping image of the target template image have a same non-identity attribute. A process of invoking the trained identity swapping model to perform identity swapping processing on the target template image based on the target source image is similar to the process of invoking the identity swapping model to perform identity swapping processing on the fake template image based on the first source image in operation S302. For details, refer to descriptions of operation S302. Details are not described herein again.

In some embodiments, through a preparation process of a fake template sample group, there may be a real labeled image in a training process of an identity swapping model. In other words, the real labeled image may be used to constrain the training process of the identity swapping model, so that the training process of the identity swapping model may be more uncontrollable, to help to improve quality of an identity swapping image generated by the identity swapping model. Through a preparation process of a fake labeled sample group, a real template image may be consistent with a template image used in a real identity swapping scenario, which makes up for a defect that a fake template image constructed in the fake template sample group is inconsistent with the template image used in the real identity swapping scenario, and further improves controllability of the training process of the identity swapping model and the quality of the identity swapping image generated by the identity swapping model. In addition, in some embodiments, loss information of the identity swapping model is calculated from different dimensions (a pixel difference dimension, a feature difference dimension, a similarity of face features, an adversarial model dimension, and the like), so that the identity swapping model may be optimized from different dimensions, to improve a training effect of the identity swapping model.

The method according to some embodiments are described in detail above. For ease of better implementing the foregoing solutions, an apparatus according to some embodiments is correspondingly provided in the following.

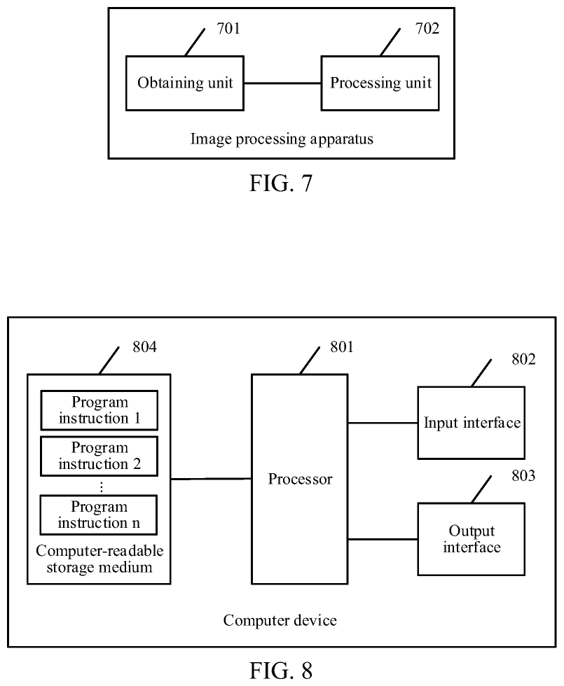

FIG. 7 is a schematic structural diagram of an image processing apparatus according to some embodiments. The image processing apparatus may be disposed on a computer device provided in some embodiments, where the computer device may be the server 201 in the method embodiments. The image processing apparatus shown in FIG. 7 may be a computer program (including program code) running in the computer device, and the image processing apparatus may be configured to perform part of or all operations in the method embodiment shown in FIG. 3 or FIG. 5. Referring to FIG. 7, the image processing apparatus includes the following units:
an obtaining unit 701, configured to obtain a fake template sample group, the fake template sample group including a first source image, a fake template image, and a real labeled image, the fake template image being obtained by performing identity swapping processing on the real labeled image, the first source image and the real labeled image having a same identity attribute, and the fake template image and the real labeled image having a same non-identity attribute; and
a processing unit 702, configured to invoke an identity swapping model to perform identity swapping processing on the fake template image based on the first source image, to obtain a first identity swapping image of the fake template image,
the obtaining unit 701 being further configured to obtain a fake labeled sample group, the fake labeled sample group including a second source image, a real template image, and a fake labeled image, the fake labeled image being obtained by performing identity swapping processing on the real template image based on the second source image, the second source image and the fake labeled image having a same identity attribute, and the real template image and the fake labeled image having a same non-identity attribute;
the processing unit 702 being further configured to invoke the identity swapping model to perform identity swapping processing on the real template image based on the second source image, to obtain a second identity swapping image of the real template image; and
the processing unit 702 being further configured to train the identity swapping model based on the fake template sample group, the first identity swapping image, the fake labeled sample group, and the second identity swapping image, to use a trained identity swapping model to perform identity swapping processing on a target template image based on a target source image.

In some embodiments, when the processing unit 702 is configured to train the identity swapping model based on the fake template sample group, the first identity swapping image, the fake labeled sample group, and the second identity swapping image, the processing unit 702 is, in some embodiments, configured to perform the following operations:
determining a pixel reconstruction loss of the identity swapping model based on a first pixel difference between the first identity swapping image and the real labeled image and a second pixel difference between the second identity swapping image and the fake labeled image;
determining a feature reconstruction loss of the identity swapping model based on a feature difference between the first identity swapping image and the real labeled image;
extracting face features of the first identity swapping image, the first source image, the fake template image, the second identity swapping image, the second source image, and the real template image, to determine an identity loss of the identity swapping model;
performing discriminative processing on the first identity swapping image and the second identity swapping image, to obtain an adversarial loss of the identity swapping model; and
performing summation on the pixel reconstruction loss, the feature reconstruction loss, the identity loss, and the adversarial loss of the identity swapping model, to obtain loss information of the identity swapping model, and updating model parameters of the identity swapping model based on the loss information of the identity swapping model, to train the identity swapping model.

In some embodiments, when the processing unit 702 is configured to determine the feature reconstruction loss of the identity swapping model based on the feature difference between the first identity swapping image and the real labeled image, the processing unit 702 is, in some embodiments, configured to perform the following operations:
obtaining an image feature extraction network, where the image feature extraction network includes a plurality of image feature extraction layers;
invoking the image feature extraction network to perform image feature extraction on the first identity swapping image, to obtain a first feature extraction result, where the first feature extraction result includes an identity swapping image feature extracted from each image feature extraction layer in the plurality of image feature extraction layers;
invoking the image feature extraction network to perform image feature extraction on the real labeled image, to obtain a second feature extraction result, where the second feature extraction result includes a labeled image feature extracted from each image feature extraction layer in the plurality of image feature extraction layers;
calculating a feature difference between the identity swapping image feature and the labeled image feature that are extracted from each image feature extraction layer; and
performing summation on feature differences of the image feature extraction layers, to obtain the feature reconstruction loss of the identity swapping model.

In some embodiments, the identity loss of the identity swapping model includes a first identity loss and a second identity loss; and when extracting the face features of the first identity swapping image, the first source image, the fake template image, the second identity swapping image, the second source image, and the real template image, to determine the identity loss of the identity swapping model, the processing unit 702 is, in some embodiments, configured to perform the following operations:
determining the first identity loss based on a similarity between face features of the first identity swapping image and face features of the first source image and a similarity between face features of the second identity swapping image and face features of the second source image; and

determining the second identity loss based on a similarity between the face features of the first identity swapping image and face features of the fake template image, a similarity between the face features of the first source image and the face features of the fake template image, a similarity between the face features of the second identity swapping image and face features of the real template image, and a similarity between the face features of the second source image and the face features of the real template image.

In some embodiments, when the processing unit 702 is configured to perform discriminative processing on the first identity swapping image and the second identity swapping image, to obtain the adversarial loss of the identity swapping model, the processing unit 702 is, in some embodiments, configured to perform the following operations:
obtaining a discriminative model;
invoking the discriminative model to perform discriminative processing on the first identity swapping image, to obtain a first discriminative result;
invoking the discriminative model to perform discriminative processing on the second identity swapping image, to obtain a second discriminative result; and
determining the adversarial loss of the identity swapping model based on the first discriminative result and the second discriminative result.

In some embodiments, when the processing unit 702 is configured to determine the pixel reconstruction loss of the identity swapping model based on the first pixel difference between the first identity swapping image and the real labeled image and the second pixel difference between the second identity swapping image and the fake labeled image, the processing unit 702 is, in some embodiments, configured to perform the following operations:
obtaining a first weight corresponding to the first pixel difference and a second weight corresponding to the second pixel difference;
performing weighted processing on the first pixel difference based on the first weight, to obtain a first weighted pixel difference;
performing weighted processing on the second pixel difference based on the second weight, to obtain a second weighted pixel difference; and
performing summation on the first weighted pixel difference and the second weighted pixel difference, to obtain the pixel reconstruction loss of the identity swapping model.

In some embodiments, the identity swapping model includes an encoding network and a decoding network; and when invoking the identity swapping model to perform identity swapping processing on the fake template image based on the first source image, to obtain the first identity swapping image of the fake template image, the processing unit 702 is, in some embodiments, configured to perform the following operations:
invoking the encoding network to perform fusion encoding processing on the first source image and the fake template image, to obtain an encoding result; and
invoking the decoding network to perform decoding processing on the encoding result, to obtain the first identity swapping image of the fake template image.

In some embodiments, when the processing unit 702 is configured to invoke the encoding network to perform fusion encoding processing on the first source image and the fake template image, to obtain the encoding result, the processing unit 702 is, in some embodiments, configured to perform the following operations:
performing splicing processing on the first source image and the fake template image, to obtain a spliced image;
performing feature learning on the spliced image, to obtain identity swapping features;
performing face feature recognition on the first source image, to obtain face features of the first source image; and
performing feature fusion processing on the identity swapping features and the face features of the first source image, to obtain the encoding result.

In some embodiments, when the processing unit 702 is configured to perform feature fusion processing on the identity swapping features and the face features of the first source image, to obtain the encoding result, the processing unit 702 is, in some embodiments, configured to perform the following operations:
calculating a mean of the identity swapping features and a variance of the identity swapping features;
calculating a mean of the face features and a variance of the face features; and
performing feature fusion processing on the identity swapping features and the face features based on the mean of the identity swapping features, the variance of the identity swapping features, the mean of the face features, and the variance of the face features, to obtain the encoding result.

In some embodiments, when the obtaining unit 701 is configured to obtain the fake template sample group, the obtaining unit 701 is, in some embodiments, configured to perform the following operations:
obtaining an initial source image corresponding to the first source image, and obtaining an initial labeled image corresponding to the real labeled image;
performing face region cropping on the initial source image corresponding to the first source image, to obtain the first source image, and performing face region cropping on the initial labeled image corresponding to the real labeled image, to obtain the real labeled image;
obtaining a reference source image, and performing identity swapping processing on the real labeled image based on the reference source image, to obtain the fake template image; and
generating the fake template sample group based on the first source image, the fake template image, and the real labeled image.

In some embodiments, when the obtaining unit 701 is configured to perform face region cropping on the initial source image corresponding to the first source image, to obtain the first source image, the obtaining unit 701 is, in some embodiments, configured to perform the following operations:
performing face detection on the initial source image corresponding to the first source image, to determine a face region in the initial source image corresponding to the first source image;
performing, in the face region, face registration on the initial source image corresponding to the first source image, to determine face key points in the initial source image corresponding to the first source image; and
performing cropping processing on the initial source image corresponding to the first source image based on the face key points, to obtain the first source image.

In some embodiments, the processing unit 702 is further configured to perform the following operations:
receiving the target source image and the target template image that are to be processed; and
invoking the trained identity swapping model to perform identity swapping processing on the target template image based on the target source image, to obtain an identity swapping image of the target template image, where
the target source image and the identity swapping image of the target template image have a same identity attribute, and the target template image and the identity swapping image of the target template image have a same non-identity attribute.

A person skilled in the art would understand that the above “units” could be implemented by hardware logic, a processor or processors executing computer software code, or a combination of both. The “units” may also be implemented in software stored in a memory of a computer or a non-transitory computer-readable medium, where the instructions of each unit are executable by a processor to thereby cause the processor to perform the respective operations of the corresponding unit.

According to some embodiments, the units of the image processing apparatus shown in FIG. 7 may be separately or wholly combined into one or several other units, or one (or more) of the units may further be divided into a plurality of units of smaller functions. In this way, same operations may be implemented, and the implementation of the technical effects is not affected. The foregoing units are divided based on logical functions. In some embodiments, a function of one unit may also be implemented by multiple units, or functions of multiple units are implemented by one unit. In some embodiments, the image processing apparatus may also include other units. In some embodiments, the functions may also be cooperatively implemented by other units and may be cooperatively implemented by a plurality of units.

According to some embodiments, a computer program (including program code) that can perform operations in part of or all methods shown in FIG. 3 or FIG. 5 may be run on a general computing device, such as a computer, which includes processing elements and storage elements such as a central processing unit (CPU), a random access memory (RAM), and a read-only memory (ROM), to construct the image processing apparatus shown in FIG. 7 and implement the image processing method according to some embodiments. The computer program may be recorded in, for example, a computer-readable storage medium, and may be loaded into the foregoing computing device by using the non-transitory computer-readable storage medium, and run in the computing device.

In some embodiments, a fake template sample group and a fake labeled sample group that are configured for training an identity swapping model are provided. In the fake template sample group, a fake template image is constructed by performing identity swapping processing on a real labeled image. In this way, there may be a real labeled image in a training process of the identity swapping model. In other words, the real labeled image may be used to constrain the training process of the identity swapping model, so that the training process of the identity swapping model may be more uncontrollable, to help to improve quality of an identity swapping image generated by the identity swapping model. In the fake labeled sample group, a fake labeled image is constructed by performing identity swapping processing on a real template image by using a source image. In this way, the real template image may be consistent with a template image used in a real identity swapping scenario, which makes up for a defect that a fake template image constructed in the fake template sample group is inconsistent with the template image used in the real identity swapping scenario, and further improves controllability of the training process of the identity swapping model and the quality of the identity swapping image generated by the identity swapping model.

Based on the foregoing method and apparatus embodiments, some embodiments provide a computer device. The computer device may be the server 201 in the foregoing descriptions. FIG. 8 is a schematic structural diagram of a computer device according to some embodiments. The computer device shown in FIG. 8 includes at least a processor 801, an input interface 802, an output interface 803, and a computer-readable storage medium 804. The processor 801, the input interface 802, the output interface 803, and the computer-readable storage medium 804 may be connected by using a bus or in another manner.

The computer-readable storage medium 804 may be stored in a memory of the computer device. The computer-readable storage medium 804 is configured to store a computer program. The computer program includes computer instructions. The processor 801 is configured to execute program instructions stored in the computer-readable storage medium 804. The processor 801 (or referred to as a central processing unit (CPU)) is a computing core and a control core of the computer device, is adapted to implement one or more computer instructions, and is, in some embodiments, adapted to load and execute the one or more computer instructions to implement a corresponding method procedure or a corresponding function.

Some embodiments further provide a non-transitory computer-readable storage medium, and the computer-readable storage medium is a memory device in a computer device and is configured to store programs and data. It may be understood that the computer-readable storage medium herein may include an internal storage medium of the computer device and certainly may also include an extended storage medium supported by the computer device. The computer-readable storage medium provides storage space, and the storage space stores an operating system of the computer device. Moreover, computer instructions suitable for a processor to load and execute are further stored in the memory space. The computer instructions may be one or more computer programs (including program code). The computer-readable storage medium herein may be a high-speed RAM memory, or a non-volatile memory, such as at least one disk memory. In some embodiments, the computer-readable storage medium may be at least one computer-readable storage medium far away from the foregoing processor.

In some embodiments, the processor 801 may load and execute one or more computer instructions stored in the computer-readable storage medium 804, to implement corresponding operations of the image processing method shown in FIG. 3 or FIG. 5. During implementation of some embodiments, the computer instructions in the computer-readable storage medium 804 are loaded by the processor 801 to perform the following operations:
obtaining a fake template sample group, the fake template sample group including a first source image, a fake template image, and a real labeled image, the fake template image being obtained by performing identity swapping processing on the real labeled image, the first source image and the real labeled image having a same identity attribute, and the fake template image and the real labeled image having a same non-identity attribute;
invoking an identity swapping model to perform identity swapping processing on the fake template image based on the first source image, to obtain a first identity swapping image of the fake template image;
obtaining a fake labeled sample group, the fake labeled sample group including a second source image, a real template image, and a fake labeled image, the fake labeled image being obtained by performing identity swapping processing on the real template image based on the second source image, the second source image and the fake labeled image having a same identity attribute, and the real template image and the fake labeled image having a same non-identity attribute;
invoking the identity swapping model to perform identity swapping processing on the real template image based on the second source image, to obtain a second identity swapping image of the real template image; and
training the identity swapping model based on the fake template sample group, the first identity swapping image, the fake labeled sample group, and the second identity swapping image.

In some embodiments, when the computer instructions in the computer-readable storage medium 804 are loaded by the processor 801 to train the identity swapping model based on the fake template sample group, the first identity swapping image, the fake labeled sample group, and the second identity swapping image, the computer instructions are, in some embodiments, configured to perform the following operations:
determining a pixel reconstruction loss of the identity swapping model based on a first pixel difference between the first identity swapping image and the real labeled image and a second pixel difference between the second identity swapping image and the fake labeled image;
determining a feature reconstruction loss of the identity swapping model based on a feature difference between the first identity swapping image and the real labeled image;
extracting face features of the first identity swapping image, the first source image, the fake template image, the second identity swapping image, the second source image, and the real template image, to determine an identity loss of the identity swapping model;
performing discriminative processing on the first identity swapping image and the second identity swapping image, to obtain an adversarial loss of the identity swapping model; and
performing summation on the pixel reconstruction loss, the feature reconstruction loss, the identity loss, and the adversarial loss of the identity swapping model, to obtain loss information of the identity swapping model, and updating model parameters of the identity swapping model based on the loss information of the identity swapping model, to train the identity swapping model.

In some embodiments, when the computer instructions in the computer-readable storage medium 804 are loaded by the processor 801 to determine the feature reconstruction loss of the identity swapping model based on the feature difference between the first identity swapping image and the real labeled image, the computer instructions are, in some embodiments, configured to perform the following operations:
obtaining an image feature extraction network, where the image feature extraction network includes a plurality of image feature extraction layers;
invoking the image feature extraction network to perform image feature extraction on the first identity swapping image, to obtain a first feature extraction result, where the first feature extraction result includes an identity swapping image feature extracted from each image feature extraction layer in the plurality of image feature extraction layers;
invoking the image feature extraction network to perform image feature extraction on the real labeled image, to obtain a second feature extraction result, where the second feature extraction result includes a labeled image feature extracted from each image feature extraction layer in the plurality of image feature extraction layers;
calculating a feature difference between the identity swapping image feature and the labeled image feature that are extracted from each image feature extraction layer; and
performing summation on feature differences of the image feature extraction layers, to obtain the feature reconstruction loss of the identity swapping model.

In some embodiments, the identity loss of the identity swapping model includes a first identity loss and a second identity loss; and when the computer instructions in the computer-readable storage medium 804 are loaded by the processor 801 to extract the face features of the first identity swapping image, the first source image, the fake template image, the second identity swapping image, the second source image, and the real template image, to determine the identity loss of the identity swapping model, the computer instructions are, in some embodiments, configured to perform the following operations:
determining the first identity loss based on a similarity between face features of the first identity swapping image and face features of the first source image and a similarity between face features of the second identity swapping image and face features of the second source image; and

determining the second identity loss based on a similarity between the face features of the first identity swapping image and face features of the fake template image, a similarity between the face features of the first source image and the face features of the fake template image, a similarity between the face features of the second identity swapping image and face features of the real template image, and a similarity between the face features of the second source image and the face features of the real template image.

In some embodiments, when the computer instructions in the computer-readable storage medium 804 are loaded by the processor 801 to perform discriminative processing on the first identity swapping image and the second identity swapping image, to obtain the adversarial loss of the identity swapping model, the computer instructions are, in some embodiments, configured to perform the following operations:
obtaining a discriminative model;
invoking the discriminative model to perform discriminative processing on the first identity swapping image, to obtain a first discriminative result;
invoking the discriminative model to perform discriminative processing on the second identity swapping image, to obtain a second discriminative result; and
determining the adversarial loss of the identity swapping model based on the first discriminative result and the second discriminative result.

In some embodiments, when the computer instructions in the computer-readable storage medium 804 are loaded by the processor 801 to determine the pixel reconstruction loss of the identity swapping model based on the first pixel difference between the first identity swapping image and the real labeled image and the second pixel difference between the second identity swapping image and the fake labeled image, the computer instructions are, in some embodiments, configured to perform the following operations:
obtaining a first weight corresponding to the first pixel difference and a second weight corresponding to the second pixel difference;
performing weighted processing on the first pixel difference based on the first weight, to obtain a first weighted pixel difference;
performing weighted processing on the second pixel difference based on the second weight, to obtain a second weighted pixel difference; and
performing summation on the first weighted pixel difference and the second weighted pixel difference, to obtain the pixel reconstruction loss of the identity swapping model.

In some embodiments, the identity swapping model includes an encoding network and a decoding network; and when the computer instructions in the computer-readable storage medium 804 are loaded by the processor 801 to invoke the identity swapping model to perform identity swapping processing on the fake template image based on the first source image, to obtain the first identity swapping image of the fake template image, the computer instructions are, in some embodiments, configured to perform the following operations:
invoking the encoding network to perform fusion encoding processing on the first source image and the fake template image, to obtain an encoding result; and
invoking the decoding network to perform decoding processing on the encoding result, to obtain the first identity swapping image of the fake template image.

In some embodiments, when the computer instructions in the computer-readable storage medium 804 are loaded by the processor 801 to invoke the encoding network to perform fusion encoding processing on the first source image and the fake template image, to obtain the encoding result, the computer instructions are, in some embodiments, configured to perform the following operations:
performing splicing processing on the first source image and the fake template image, to obtain a spliced image;
performing feature learning on the spliced image, to obtain identity swapping features;
performing face feature recognition on the first source image, to obtain face features of the first source image; and
performing feature fusion processing on the identity swapping features and the face features of the first source image, to obtain the encoding result.

In some embodiments, when the computer instructions in the computer-readable storage medium 804 are loaded by the processor 801 to perform feature fusion processing on the identity swapping features and the face features of the first source image, to obtain the encoding result, the computer instructions are, in some embodiments, configured to perform the following operations:
calculating a mean of the identity swapping features and a variance of the identity swapping features;
calculating a mean of the face features and a variance of the face features; and
performing feature fusion processing on the identity swapping features and the face features based on the mean of the identity swapping features, the variance of the identity swapping features, the mean of the face features, and the variance of the face features, to obtain the encoding result.

In some embodiments, when the computer instructions in the computer-readable storage medium 804 are loaded by the processor 801 to obtain the fake template sample group, the computer instructions are, in some embodiments, configured to perform the following operations:
obtaining an initial source image corresponding to the first source image, and obtaining an initial labeled image corresponding to the real labeled image;
performing face region cropping on the initial source image corresponding to the first source image, to obtain the first source image, and performing face region cropping on the initial labeled image corresponding to the real labeled image, to obtain the real labeled image;
obtaining a reference source image, and performing identity swapping processing on the real labeled image based on the reference source image, to obtain the fake template image; and
generating the fake template sample group based on the first source image, the fake template image, and the real labeled image.

In some embodiments, when the computer instructions in the computer-readable storage medium 804 are loaded by the processor 801 to perform face region cropping on the initial source image corresponding to the first source image, to obtain the first source image, the computer instructions are, in some embodiments, configured to perform the following operations:
performing face detection on the initial source image corresponding to the first source image, to determine a face region in the initial source image corresponding to the first source image;
performing, in the face region, face registration on the initial source image corresponding to the first source image, to determine face key points in the initial source image corresponding to the first source image; and
performing cropping processing on the initial source image corresponding to the first source image based on the face key points, to obtain the first source image.

In some embodiments, the computer instructions in the computer-readable storage medium 804 are loaded by the processor 801 to further perform the following operations:
receiving the target source image and the target template image that are to be processed; and
invoking the trained identity swapping model to perform identity swapping processing on the target template image based on the target source image, to obtain an identity swapping image of the target template image, where
the target source image and the identity swapping image of the target template image have a same identity attribute, and the target template image and the identity swapping image of the target template image have a same non-identity attribute.

In some embodiments, a fake template sample group and a fake labeled sample group that are configured for training an identity swapping model are provided. In the fake template sample group, a fake template image is constructed by performing identity swapping processing on a real labeled image. In this way, there may be a real labeled image in a training process of the identity swapping model. In other words, the real labeled image may be used to constrain the training process of the identity swapping model, so that the training process of the identity swapping model may be more uncontrollable, to help to improve quality of an identity swapping image generated by the identity swapping model. In the fake labeled sample group, a fake labeled image is constructed by performing identity swapping processing on a real template image by using a source image. In this way, the real template image may be consistent with a template image used in a real identity swapping scenario, which makes up for a defect that a fake template image constructed in the fake template sample group is inconsistent with the template image used in the real identity swapping scenario, and further improves controllability of the training process of the identity swapping model and the quality of the identity swapping image generated by the identity swapping model. According to some embodiments, a computer program product or a computer program is provided, the computer program product or the computer program including computer instructions, the computer instructions being stored in a computer-readable storage medium. A processor of a computer device reads the computer instructions from the computer-readable storage medium, and the processor executes the computer instructions, so that the computer device performs the image processing method provided in the various manners.

According to some embodiments, a computer program product or a computer program is provided, the computer program product or the computer program including computer instructions, the computer instructions being stored in a computer-readable storage medium. A processor of a computer device reads the computer instructions from the computer-readable storage medium, and the processor executes the computer instructions, so that the computer device performs the image processing method provided in the various manners.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. An image processing method, performed by a computer device, the image processing method comprising:
obtaining a fake template sample group comprising a first source image, a real labeled image, and a fake template image, the fake template image being based on identity swapping processing of the real labeled image, the first source image and the real labeled image having a same identity attribute, and the fake template image and the real labeled image having a same non-identity attribute;
inputting the fake template image into an identity swapping model and performing identity swapping processing on the fake template image based on the first source image to obtain a first identity swapping image of the fake template image;
obtaining a fake labeled sample group comprising a second source image, a real template image, and a fake labeled image, the fake labeled image being based on identity swapping processing of the real template image based on the second source image, the second source image and the fake labeled image having a same identity attribute, and the real template image and the fake labeled image having a same non-identity attribute;
inputting the real template image into the identity swapping model and performing identity swapping processing on the real template image based on the second source image to obtain a second identity swapping image of the real template image; and
training the identity swapping model based on the fake template sample group, the first identity swapping image, the fake labeled sample group, and the second identity swapping image to generate a trained identity swapping model to perform identity swapping processing on a target template image based on a target source image.

2. The image processing method according to claim 1, wherein the training comprises:
determining a pixel reconstruction loss of the identity swapping model based on a first pixel difference between the first identity swapping image and the real labeled image and a second pixel difference between the second identity swapping image and the fake labeled image;
determining a feature reconstruction loss of the identity swapping model based on a feature difference between the first identity swapping image and the real labeled image;
extracting face features of the first identity swapping image, the first source image, the fake template image, the second identity swapping image, the second source image, and the real template image to determine an identity loss of the identity swapping model;
performing discriminative processing on the first identity swapping image and the second identity swapping image to obtain an adversarial loss of the identity swapping model; and
performing summation on the pixel reconstruction loss, the feature reconstruction loss, the identity loss, and the adversarial loss of the identity swapping model, to obtain loss information of the identity swapping model, and updating model parameters of the identity swapping model based on the loss information of the identity swapping model to train the identity swapping model.

3. The image processing method according to claim 2, wherein determining the feature reconstruction loss comprises:
obtaining an image feature extraction network comprising a plurality of image feature extraction layers;
calling the image feature extraction network to perform image feature extraction on the first identity swapping image to obtain a first feature extraction result, the first feature extraction result comprising an identity swapping image feature extracted from each image feature extraction layer of the plurality of image feature extraction layers;
calling the image feature extraction network to perform the image feature extraction on the real labeled image to obtain a second feature extraction result, the second feature extraction result comprising a labeled image feature extracted from each image feature extraction layer of the plurality of image feature extraction layers;
calculating feature differences between the identity swapping image feature and the labeled image feature that are extracted from each image feature extraction layer; and
performing summation of the feature differences of the image feature extraction layers to obtain the feature reconstruction loss of the identity swapping model.

4. The image processing method according to claim 2, wherein the identity loss of the identity swapping model comprises a first identity loss and a second identity loss; and the extracting comprises:
determining the first identity loss based on a similarity between face features of the first identity swapping image and face features of the first source image and a similarity between face features of the second identity swapping image and face features of the second source image; and
determining the second identity loss based on a similarity between the face features of the first identity swapping image and face features of the fake template image, a similarity between the face features of the first source image and the face features of the fake template image, a similarity between the face features of the second identity swapping image and face features of the real template image, and a similarity between the face features of the second source image and the face features of the real template image.

5. The image processing method according to claim 2, wherein the performing discriminative processing on the first identity swapping image and the second identity swapping image comprises:
obtaining a discriminative model;
inputting the first identity swapping image into the discriminative model and performing discriminative processing on the first identity swapping image to obtain a first discriminative result;
inputting the second identity swapping image into the discriminative model and performing discriminative processing on the second identity swapping image to obtain a second discriminative result; and
determining the adversarial loss of the identity swapping model based on the first discriminative result and the second discriminative result.

6. The image processing method according to claim 2, wherein determining the pixel reconstruction loss of the identity swapping model based on the first pixel difference between the first identity swapping image and the real labeled image and the second pixel difference between the second identity swapping image and the fake labeled image comprises:
obtaining a first weight corresponding to the first pixel difference and a second weight corresponding to the second pixel difference;
performing weighted processing on the first pixel difference based on the first weight, to obtain a first weighted pixel difference;
performing weighted processing on the second pixel difference based on the second weight, to obtain a second weighted pixel difference; and
performing summation on the first weighted pixel difference and the second weighted pixel difference, to obtain the pixel reconstruction loss of the identity swapping model.

7. The image processing method according to claim 1, wherein the identity swapping model comprises an encoding network and a decoding network; and performing the identity swapping processing on the fake template image based on the first source image comprises:
calling the encoding network to perform fusion encoding processing on the first source image and the fake template image, to obtain an encoding result; and
calling the decoding network to perform decoding processing on the encoding result to obtain the first identity swapping image of the fake template image.

8. The image processing method according to claim 7, wherein calling the encoding network to perform the fusion encoding processing on the first source image and the fake template image comprises:
performing splicing processing on the first source image and the fake template image, to obtain a spliced image;
performing feature learning on the spliced image to obtain identity swapping features;
performing face feature recognition on the first source image to obtain face features of the first source image; and
performing feature fusion processing on the identity swapping features and the face features of the first source image to obtain the encoding result.

9. The image processing method according to claim 8, wherein performing the feature fusion processing on the identity swapping features and the face features of the first source image, to obtain the encoding result comprises:
calculating a mean of the identity swapping features and a variance of the identity swapping features;
calculating a mean of the face features and a variance of the face features; and
performing the feature fusion processing on the identity swapping features and the face features based on the mean of the identity swapping features, the variance of the identity swapping features, the mean of the face features, and the variance of the face features to obtain the encoding result.

10. The image processing method according to claim 1, wherein obtaining the fake template sample group comprises:
obtaining an initial source image corresponding to the first source image, and obtaining an initial labeled image corresponding to the real labeled image;
performing face region cropping on the initial source image corresponding to the first source image, to obtain the first source image, and performing the face region cropping on the initial labeled image corresponding to the real labeled image, to obtain the real labeled image;
obtaining a reference source image, and performing the identity swapping processing on the real labeled image based on the reference source image, to obtain the fake template image; and
generating the fake template sample group based on the first source image, the fake template image, and the real labeled image.

11. The image processing method according to claim 10, wherein performing the face region cropping on the initial source image corresponding to the first source image comprises:
performing face detection on the initial source image corresponding to the first source image, to determine a face region in the initial source image corresponding to the first source image;
performing, in the face region, face registration on the initial source image corresponding to the first source image, to determine face key points in the initial source image corresponding to the first source image; and
performing cropping processing on the initial source image corresponding to the first source image based on the face key points, to obtain the first source image.

12. The image processing method according to claim 1, wherein training the identity swapping model, to use a trained identity swapping model to perform the identity swapping processing on the target template image based on the target source image comprises:
receiving the target source image and the target template image that are to be processed; and
inputting the target template image into the trained identity swapping model and performing identity swapping processing on the target template image based on the target source image to obtain an identity swapping image of the target template image, wherein
the target source image and the identity swapping image of the target template image have a same identity attribute, and the target template image and the identity swapping image of the target template image have a same non-identity attribute.

13. An image processing apparatus, comprising:
at least one memory configured to store program code; and
at least one processor configured to read the program code and operate as instructed by the program code, the program code comprising:
obtaining code configured to cause at least one of the at least one processor to obtain a fake template sample group comprising a first source image, a real labeled image, and a fake template image, the fake template image being based on identity swapping processing of the real labeled image, the first source image and the real labeled image having a same identity attribute, and the fake template image and the real labeled image having a same non-identity attribute; and
processing code configured to cause at least one of the at least one processor to input the fake template image into an identity swapping model and perform identity swapping processing on the fake template image based on the first source image, to obtain a first identity swapping image of the fake template image,
wherein the obtaining code is further configured to cause at least one of the at least one processor to obtain a fake labeled sample group comprising a second source image, a real template image, and a fake labeled image, the fake labeled image being based on identity swapping processing of the real template image based on the second source image, the second source image and the fake labeled image having a same identity attribute, and the real template image and the fake labeled image having a same non-identity attribute;
and the processing code is further configured to cause at least one of the at least one processor to:
input the real template image into the identity swapping model and perform identity swapping processing on the real template image based on the second source image, to obtain a second identity swapping image of the real template image; and
train the identity swapping model based on the fake template sample group, the first identity swapping image, the fake labeled sample group, and the second identity swapping image to generate a trained identity swapping model to perform the identity swapping processing on a target template image based on a target source image.

14. The image processing apparatus according to claim 13, wherein the processing code is further configured to cause at least one of the at least one processor to determine a pixel reconstruction loss of the identity swapping model based on a first pixel difference between the first identity swapping image and the real labeled image and a second pixel difference between the second identity swapping image and the fake labeled image;
determine a feature reconstruction loss of the identity swapping model based on a feature difference between the first identity swapping image and the real labeled image;
extract face features of the first identity swapping image, the first source image, the fake template image, the second identity swapping image, the second source image, and the real template image, to determine an identity loss of the identity swapping model;
perform discriminative processing on the first identity swapping image and the second identity swapping image, to obtain an adversarial loss of the identity swapping model; and
perform summation on the pixel reconstruction loss, the feature reconstruction loss, the identity loss, and the adversarial loss of the identity swapping model, to obtain loss information of the identity swapping model, and update model parameters of the identity swapping model based on the loss information of the identity swapping model, to train the identity swapping model.

15. The image processing apparatus according to claim 14, wherein the processing code is further configured to cause at least one of the at least one processor to obtain an image feature extraction network comprising a plurality of image feature extraction layers;
calling the image feature extraction network to perform image feature extraction on the first identity swapping image, to obtain a first feature extraction result, the first feature extraction result comprising an identity swapping image feature extracted from each image feature extraction layer of the plurality of image feature extraction layers;
calling the image feature extraction network to perform the image feature extraction on the real labeled image, to obtain a second feature extraction result, the second feature extraction result comprising a labeled image feature extracted from each image feature extraction layer of the plurality of image feature extraction layers;
calculate feature differences between the identity swapping image feature and the labeled image feature that are extracted from each image feature extraction layer; and
perform summation of the feature differences of the image feature extraction layers, to obtain the feature reconstruction loss of the identity swapping model.

16. The image processing apparatus according to claim 14, wherein the identity loss of the identity swapping model comprises a first identity loss and a second identity loss; and
the processing code is further configured to cause at least one of the at least one processor to:
determine the first identity loss based on a similarity between face features of the first identity swapping image and face features of the first source image and a similarity between face features of the second identity swapping image and face features of the second source image; and
determine the second identity loss based on a similarity between the face features of the first identity swapping image and face features of the fake template image, a similarity between the face features of the first source image and the face features of the fake template image, a similarity between the face features of the second identity swapping image and face features of the real template image, and a similarity between the face features of the second source image and the face features of the real template image.

17. The image processing apparatus according to claim 14, wherein the processing code is further configured to cause at least one of the at least one processor to:
obtain a discriminative model;
input the first identity swapping image into the discriminative model and perform discriminative processing on the first identity swapping image to obtain a first discriminative result;
input the second identity swapping image into the discriminative model and perform discriminative processing on the second identity swapping image to obtain a second discriminative result; and
determine the adversarial loss of the identity swapping model based on the first discriminative result and the second discriminative result.

18. A non-transitory computer-readable storage medium storing computer code which, when executed by at least one processor, causes the at least one processor to at least:
obtain a fake template sample group comprising a first source image, a real labeled image, and a fake template image, the fake template image being based on identity swapping processing of the real labeled image, the first source image and the real labeled image having a same identity attribute, and the fake template image and the real labeled image having a same non-identity attribute;
input the fake template image into an identity swapping model and perform identity swapping processing on the fake template image based on the first source image to obtain a first identity swapping image of the fake template image;
obtain a fake labeled sample group comprising a second source image, a real template image, and a fake labeled image, the fake labeled image being obtained by performing the identity swapping processing on the real template image based on the second source image, the second source image and the fake labeled image having a same identity attribute, and the real template image and the fake labeled image having a same non-identity attribute;
input the real template image into the identity swapping model and perform identity swapping processing on the real template image based on the second source image to obtain a second identity swapping image of the real template image; and
train the identity swapping model based on the fake template sample group, the first identity swapping image, the fake labeled sample group, and the second identity swapping image to generate a trained identity swapping model to perform the identity swapping processing on a target template image based on a target source image.

19. The non-transitory computer-readable storage medium according to claim 18, wherein the train comprises:
determining a pixel reconstruction loss of the identity swapping model based on a first pixel difference between the first identity swapping image and the real labeled image and a second pixel difference between the second identity swapping image and the fake labeled image;
determining a feature reconstruction loss of the identity swapping model based on a feature difference between the first identity swapping image and the real labeled image;
extracting face features of the first identity swapping image, the first source image, the fake template image, the second identity swapping image, the second source image, and the real template image to determine an identity loss of the identity swapping model;
performing discriminative processing on the first identity swapping image and the second identity swapping image to obtain an adversarial loss of the identity swapping model; and
performing summation on the pixel reconstruction loss, the feature reconstruction loss, the identity loss, and the adversarial loss of the identity swapping model, to obtain loss information of the identity swapping model, and updating model parameters of the identity swapping model based on the loss information of the identity swapping model to train the identity swapping model

20. The non-transitory computer-readable storage medium according to claim 19, wherein determining the feature reconstruction loss of the identity swapping model based on the feature difference between the first identity swapping image and the real labeled image comprises:
obtaining an image feature extraction network comprising a plurality of image feature extraction layers;
calling the image feature extraction network to perform image feature extraction on the first identity swapping image to obtain a first feature extraction result, the first feature extraction result comprising an identity swapping image feature extracted from each image feature extraction layer of the plurality of image feature extraction layers;
calling the image feature extraction network to perform the image feature extraction on the real labeled image to obtain a second feature extraction result, the second feature extraction result comprising a labeled image feature extracted from each image feature extraction layer of the plurality of image feature extraction layers;
calculating feature differences between the identity swapping image feature and the labeled image feature that are extracted from each image feature extraction layer; and
performing summation on the feature differences of the image feature extraction layers to obtain the feature reconstruction loss of the identity swapping model.
